(19) United States
(12) Patent Application Publication
(10) Pub. No.: US 2021/0223145 A1
(43) Pub. Date: Jul. 22, 2021

(54) A SAMPLING MACHINE WITH MULTI-CHANNEL FLOW DISTRIBUTING STRUCTURE

(71) Applicant: Taiyuan Hainachenke Instrument and Meter Co., Ltd., Taiyuan, Shanxi (CN)

(72) Inventors: Qiang LIU, Taiyuan, Shanxi (CN); Jianxin CHEN, Taiyuan, Shanxi (CN); Zhilong LIANG, Taiyuan, Shanxi (CN); Hongsong CHEN, Taiyuan, Shanxi (CN)

(21) Appl. No.: 16/309,442

(22) PCT Filed: Jun. 13, 2018
(86) PCT No.: PCT/CN2018/091014

§ 371 Date: Dec. 12, 2018

(30) Foreign Application Priority Data
Aug. 28, 2017 (CN) 201210748801.X

(51) Int. Cl. G01N 1/22; G01N 15/06

(52) U.S. Cl. CPC G01N 1/2208; G01N 15/0618

(57) ABSTRACT

The invention relates to a sampling machine with multi-channel flow distributing structure, belongs to the particulate matters collecting technology field. The invention provides a simple structure and uses the aerodynamic principle to cut particulate matters by impact to avoid dust accumulation. The invention comprises, a cutting flow-distributing machine connected with inlet of the sampling machine, multi-channel collecting pipelines are connected to the bottom of the cutting flow-distributing machine, collecting pipelines are provided with a cutting machine, a membrane component, a flow controller and a sampling pump, the cutting flow-distributing machine comprises a casing, an impact pipe, an impact plate and a distributing pipe, the impact plate, the impact pipe and the distributing pipes are mounted inside, on the top and at the bottom of the casing respectively, the impact pipe and the distributing pipes are extend to the inside of the casing.

### FIELD OF THE INVENTION

The invention relates to a sampling machine with multi-channel flow distributing structure and belongs to the technology field of particulate matters collecting.

### BACKGROUND ART

The most accurate method recognized worldwide to monitor particulate matters concentration in ambient air, is to sample the atmosphere with a particulate sampling machine, that is, collecting the atmospheric sample at a constant flow rate, and after the sample gas passing through the filter membrane, taking increment in weight of the filter membrane before and after the collection to be divided by the volume of the collected gas, the concentration of the particulate matters can be obtained. The particle size of the particulate matters is determined by the TSP, PM10, PM2.5 and other cutters selected at the sampling inlet.

The most prior sampling machines are single-channel structures. After being cut by the cutting machine, particulate matters is directly connected to the membrane by vertical pipelines, and theoretically, there is no dust accumulation. With further study of particulate matters analysis, it is required to analyze the collected samples after homogenously sampling, thereby the multi-channel particulate matters sampling machine is required for sample collection: generally, the multi-channel particulate matters sampling machine comprises an inlet, a cutting machine, a flow-distributing machine, connecting pipelines, a sampling membrane, a pump and a controller, and in the actual working process, the flow-distributing machine and the connecting pipelines are easy to accumulate dust, resulting in low data value.

### SUMMARY OF THE INVENTION

In order to solve the technical problems of the prior art, the invention provides sampling machine with multi-channel flow distributing structure and a simple structure, and uses aerodynamic principle to cut particulate matters by impact to avoid dust accumulation.

In order to achieve the above object, the invention adopts a technical scheme: a sampling machine with multi-channel flow distributing structure, comprising, a cutting flow-distributing machine which is connected to the inlet of the sampling machine, multi-channel collecting pipelines are connected to the bottom of the cutting flow-distributing machine, the collecting pipelines are provided with a cutting machine, a membrane component, a flow controller and a sampling pump, wherein the cutting flow-distributing machine comprises a casing, an impact pipe, an impact plate and a distributing pipe, the impact plate is mounted inside the casing, the impact pipe is mounted on the top of the casing, the distributing pipes are mounted at the bottom of the casing, the impact pipe and the distributing pipes are extend to the inside of the casing.

Preferably, the impact pipe and the distributing pipes are both disposed perpendicular to the impact plate.

Preferably, a catch basin is provided on the impact plate, a water outlet is provided at the bottom of the catch basin, a discharging tube is provided at the water outlet, and a water bottle is connected to the discharging tube.

Compared with the prior art, the invention has the following technical effects: The invention eliminates the independent flow distributing structure, and particulate matters cut by the cutting machine is directly distributed through evenly distributed distributing pipes, thereby being connected to the membrane by vertical connecting pipelines, which completely solves the dust accumulation caused by the flow-distributing machine and the bending pipelines of the multi-channel flow distributing sampling machine; simultaneously, the invention ensures the homologous sampling requirements of the collected samples and improves the acquisition accuracy.

### DESCRIPTION OF THE DRAWINGS

FIG. 1 is a schematic diagram showing the structure of the invention.

FIG. 2 is a schematic diagram showing the structure of the cutting flow-distributing machine in the invention.

FIG. 3 is a schematic diagram showing the principle of the cutting flow-distributing machine in the invention.

### DESCRIPTION OF THE PREFERRED EMBODIMENTS

In order to make the technical problems to be solved, technical solutions and beneficial effects more clear, the invention will be further described in detail below with reference to the accompanying drawings and embodiments. It should be understood that the specific embodiments described herein are merely illustrative of the invention and are not intended to limit the invention.

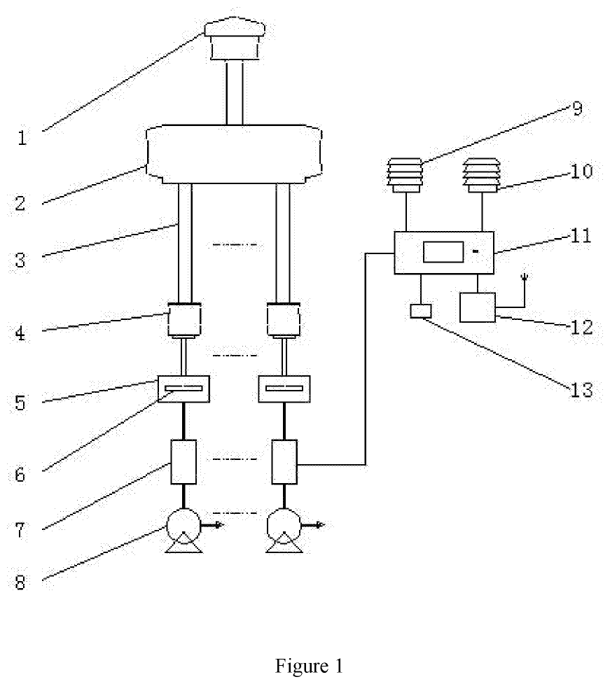

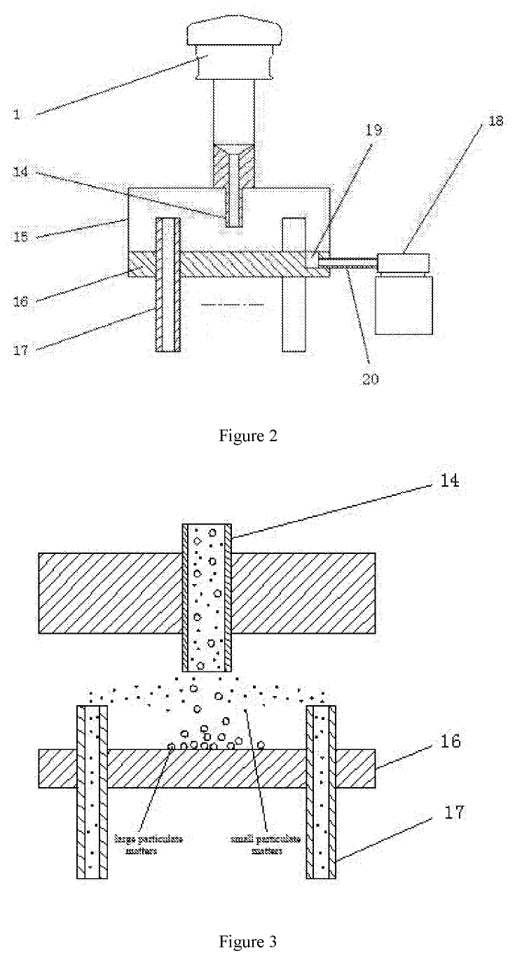

As shown in FIGS. 1 and 2, a sampling machine with multi-channel flow distributing structure, comprising, a cutting flow-distributing machine 2 which is connected to the inlet 1 of the sampling machine, multi-channel collecting pipelines 3 are connected to the bottom of the cutting flow-distributing machine 2, the collecting pipelines 3 are provided with a cutting machine 4, a membrane component 5, a flow controller 7 and a sampling pump 8, wherein the membrane component has a built-in membrane 6, the flow controller 7 and the sampling pump 8 are all connected to a master control system 11, the master control system 11 is also connected with a meteorological module 9 for detecting real-time weather information, a temperature and humidity detecting module 10 for detecting air temperature and humidity in real time, a GPS positioning module 12 for positioning real-time position information, and a RFID module 13 for membrane detecting; the cutting flow-distributing machine 2 comprises a casing 15, an impact pipe 14, an impact plate 16 and distributing pipes 17, the impact plate 16 is mounted inside the casing 15, the impact pipe 14 is mounted on the top of the casing 15, the distributing pipes 17 are mounted at the bottom of the casing 15, the impact pipe 14 and the distributing pipes 17 are extend to the inside of the casing 15.

The cutting machine in the can be the overlapped combination of TSP, PM10, PM5, PM2.5, and PM1.0, or overlapped combination of PM10, PM5, PM2.5, and PM1.0. When in use, the cutting flow-distributing machine cuts and distributes the collected particulate matters, which mainly uses aerodynamic principle to cut particulate matters by impact. The inertia of particulate matters with different partial size are different, and for gas flowing in the impact pipes and particulate matters in different size, the large particulate matters is cut and precipitated on the impact plate when encounter the impact plate for the lager inertia thereof, while the small particulate matters flows to next stage together with the gas. By varying the gas flow rate and the height of the impact plate and the impact pipes, particulate matters in different sizes and with aerodynamic equivalent diameter can be cut. Particulate matters and gas flowing to next stage after cutting are distributed through evenly distributed distributing pipes, thereby homologous multi-channel sampled particulate matters is obtained. And the particulate matters and gas are connected to the membrane by vertical connecting pipelines, which completely solves the dust accumulation caused by the flow-distributing machine and the bending pipelines of the multi-channel flow distributing sampling machine; simultaneously, the invention ensures the homologous sampling requirements of the collected samples and improves the acquisition accuracy.

When cutting and distributing particulate matters, the cutting particle size d of the particulate matters is calculated. The theoretical formula for the particle size d is:

$$d = \sqrt{\frac{9 k η D}{ρ CU}} ,$$

wherein, k is non-dimensional coefficient, η is the Aerodynamic viscosity coefficient, D is the diameter of the impact pipe, ρ is the mass concentration of the particulate matters, C is Cunningham slipstream index, U is the flow rate of the impact pipe. According to the above formula, the suitable cutting particle size can be determined to improve the acquisition accuracy.

In addition, the impact pipe 14 and the distributing pipes 17 are both disposed perpendicular to the impact plate 16, which can greatly improve the cutting and distributing effect. A catch basin 19 is provided on the impact plate 16, a water outlet is provided at the bottom of the catch basin 19, a discharging tube 20 is provided at the water outlet, and a water bottle 18 is connected to the discharging tube. The catch basin is used to collect the water in particulate matters and the water enters the water bottle through the water outlet, which is more convenient in use.

The above is only the preferred embodiment of the invention, and is not intended to limit the invention. Any modifications, equivalents, and improvements made within the spirit and scope of the invention should be included in the scope of the invention.

1. A sampling machine with multi-channel flow distributing structure, comprising, a cutting flow-distributing machine which is connected to the inlet of the sampling machine, multi-channel collecting pipelines are connected to the bottom of the cutting flow-distributing machine, the collecting pipelines are provided with a cutting machine, a membrane component, a flow controller and a sampling pump, wherein the cutting flow-distributing machine comprises a casing, an impact pipe, an impact plate and distributing pipes, the impact plate is mounted inside the casing, the impact pipe is mounted on the top of the casing, the distributing pipes are mounted at the bottom of the casing, the impact pipe and the distributing pipes are extend to the inside of the casing, the cutting machine comprises overlapping combinations of PM10, PM5, PM2.5, and PM1.0.

2. The sampling machine with multi-channel flow distributing structure of claim 1, wherein the impact pipe and the distributing pipes are both disposed perpendicular to the impact plate.

3. The sampling machine with multi-channel flow distributing structure of claim 1, wherein a catch basin is provided on the impact plate, a water outlet is provided at the bottom of the catch basin, a discharging tube is provided at the water outlet, and a water bottle is connected to the discharging tube.

4. The sampling machine with multi-channel flow distributing structure of claim 1, wherein the cutting machine is overlapped combination of TSP, PM10, PM5, PM2.5, and PM1.0, or overlapping combination of PM10, PM5, PM2.5, and PM1.0.
